(19) United States
(12) Patent Application Publication
(10) Pub. No.: US 2024/0340333 A1
(43) Pub. Date: Oct. 10, 2024

(54) FILE TRANSFER VERIFICATION

(71) Applicant: INTERNATIONAL BUSINESS MACHINES CORPORATION, ARMONK, NY (US)

(72) Inventors: JunXing Yang, Shenzhen (CN); XueJun Zhong, Shenzhen (CN)

(21) Appl. No.: 18/295,984

(22) Filed: Apr. 5, 2023

(51) Int. Cl. H04L 67/06

(52) U.S. Cl. CPC H04L 67/06

(57) ABSTRACT

A method, computer system, and a computer program product for file transfer verification is provided. The present invention may include detecting a request to transmit a file from a user device to a target recipient. The present invention may also include extracting a recipient information associated with the target recipient. The present invention may further include marking the file on the user device to indicate the recipient information. The present invention may also include receiving a confirmation from the user device to transmit the file to the target recipient. The present invention may further include transmitting the file from the user device to the target recipient.

### BACKGROUND

The present invention relates generally to the field of computing, and more particularly to real-time communication technologies.

Billions of people use social media and instant messaging platforms for communicating with others in real-time. One important aspect of real-time communication is the sharing, transferring, or transmitting of data files between different users over the Internet or another network connection.

### SUMMARY

Embodiments of the present invention disclose a method, computer system, and a computer program product for file transfer verification. The present invention may include detecting a request to transmit a file from a user device to a target recipient. The present invention may also include extracting a recipient information associated with the target recipient. The present invention may further include marking the file on the user device to indicate the recipient information. The present invention may also include receiving a confirmation from the user device to transmit the file to the target recipient. The present invention may further include transmitting the file from the user device to the target recipient.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is an operational flowchart illustrating a file transfer verification process according to at least one embodiment; and

FIG. 3 is a schematic block diagram of an operational example of the file transfer verification process according to at least one embodiment.

### DETAILED DESCRIPTION

The following described exemplary embodiments provide a system, method and computer program product for file transfer verification. As such, the present embodiment has the capacity to improve the technical field of real-time communications by verifying with a sending user that a correct file is being sent to a correct recipient to avoid accidentally sending a file to the wrong recipient. More specifically a file transfer verification program may detect a request to transmit a file from a user device to a target recipient. Then, the file transfer verification program may extract a recipient information associated with the target recipient. Next, the file transfer verification program may mark the file on the user device to indicate the recipient information. Then, the file transfer verification program may receive a confirmation from the user device to transfer the file to the target recipient. Thereafter, the file transfer verification program may transmit the file from the user device to the target recipient.

As described previously, billions of people use social media and instant messaging platforms for communicating with others in real-time. One important aspect of real-time communication is the sharing, transferring, or transmitting of data files between different users over the Internet or another network connection. Users often prefer the ease of instant messaging applications over electronic mail (e-mail) for sharing data files, such as, photos, videos, and other documents. However, in some instances, a user may mistakenly send a file to the wrong individuals, and sometimes even to the wrong group, causing hundreds or thousands of group members to receive the user's file by mistake. Such mistakes may lead to serious privacy violations. Further, if files containing confidential information are transmitted by mistake, the error may lead to economic loss or legal consequences for the user.

Therefore, it may be advantageous to, among other things, provide a way to verify and confirm a file transfer request to ensure that users do not mistakenly send data files to the wrong recipients.

According to one embodiment, when a user chooses to send a file (e.g., photo, video, or other document) to another party, the file transfer verification program may automatically extract the name of the recipient or the receiving group that may receive the file.

In one embodiment, the file transfer verification program may provide a first reminder to remind the user of who will receive the file, and at the same time remind the user whether the target recipient is an individual or a group. In one embodiment, the file transfer verification program may automatically mark and display the names of the recipients or group above the file icon (e.g., thumbnail image of the file).

If the target recipient is a group, the file transfer verification program may also extract the number of members in the group and provide a second reminder to remind the user of the number of people in the group who may receive the file.

According to one embodiment, the file transfer verification program may provide a third reminder by graphically modifying the selected file icon based on whether the target recipient is an individual/single recipient or a group (e.g., multiple recipients).

For example, if the user sends a file to a single recipient through an instant messaging application, the selected file may be automatically marked using a first color (e.g., green) or other graphical modification. In one embodiment, the single recipient's name (e.g., real name or username) may be extracted and marked on the selected file in addition to the first graphical modification.

However, if the user sends the file to a distribution group or plurality of recipients through the instant messaging application, the selected file may be automatically marked using a second color (e.g., red) or other graphical modification. In one embodiment, the group name or the multiple recipients' names (e.g., real name or username) may be extracted and marked on the selected file in addition to the second graphical modification.

According to one embodiment, the file transfer verification program may enable users to choose and customize the first graphical modification (e.g., first distinct color) indicating a single recipient, the second graphical modification (e.g., second distinct color) indicating the multiple or group of recipients, as well as the name and number of people to be marked.

According to one embodiment, the file transfer verification program may provide an additional verification by generating and displaying a summary report for the user before the file is transferred to the recipients. In one embodiment, the summary report may include the recipient or group name, the number of files selected by the user to be transferred, the name of each file, the size of each file, and the total size of all the files. In one embodiment, the summary report may include a final confirmation request for the user and the file transfer verification program may wait for the user's final confirmation before transferring the files to the recipient.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

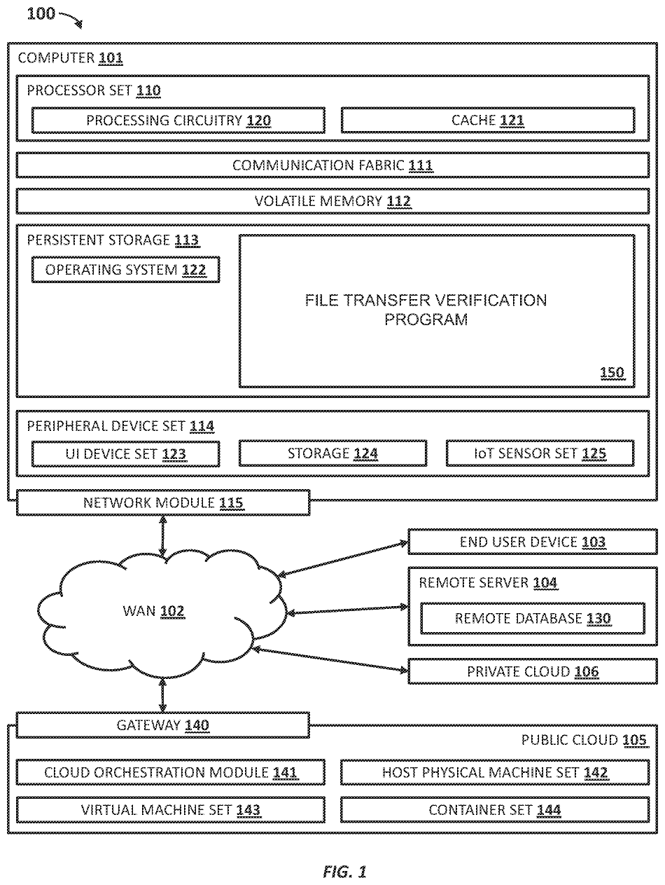

Referring to FIG. 1, a computing environment 100 according to at least one embodiment is depicted. Computing environment 100 contains an example of an environment for the execution of at least some of the computer code involved in performing the inventive methods, such as file transfer verification program 150. In addition to file transfer verification program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and file transfer verification program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, file transfer verification program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The file transfer verification program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

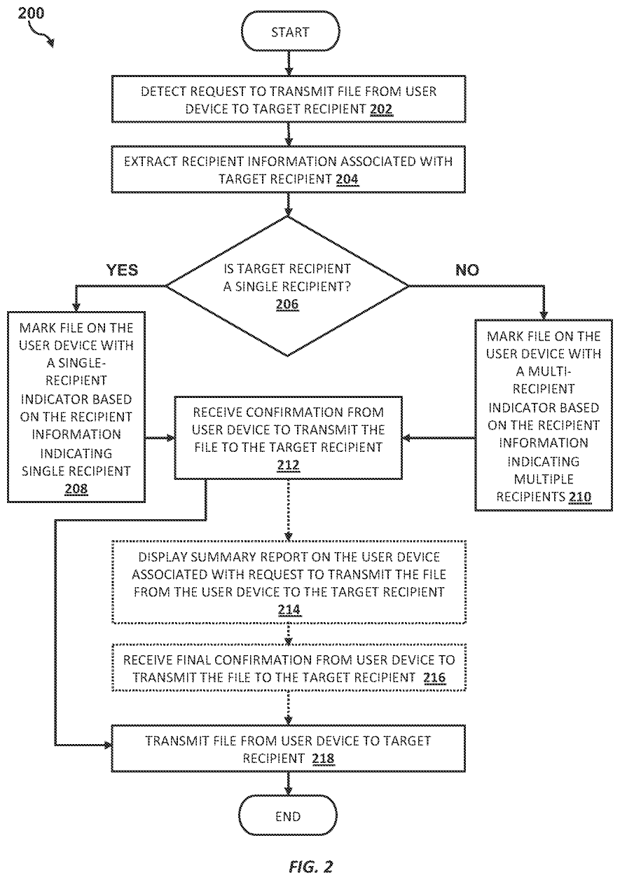

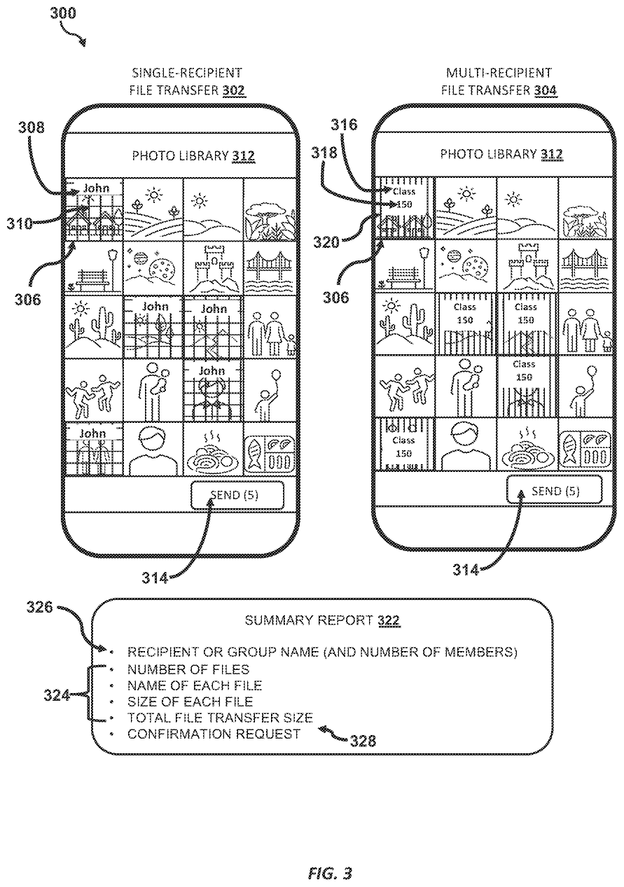

According to the present embodiment, a user interacting with the computer environment 100 (e.g., FIG. 1), using any combination of computer 101, EUD 103, remote server 104, public cloud 105, and private cloud 106 may use the file transfer verification program 150 to verify and confirm that the correct files are being transferred to the intended recipients. Embodiments of the present disclosure are explained in more detail below with respect to FIGS. 2 and 3.

Referring now to FIG. 2, an operational flowchart illustrating an exemplary file transfer verification process 200 used by the file transfer verification program 150 according to at least one embodiment is depicted.

In one embodiment, the file transfer verification program 150 may include a single computer program or multiple program modules or sets of instructions being executed by one or more processors computer environment 100 (e.g., processor set 110 of computer 101, processor of EUD 103, processor of remote server 104). In one embodiment, the file transfer verification program 150 may include routines, objects, components, units, logic, data structures, and actions that may perform particular tasks or implement particular abstract data types. In one embodiment, the file transfer verification program 150 may be practiced in distributed cloud computing environments where tasks may be performed by local and/or remote processing devices which may be linked through a communication network. In at least one embodiment, the file transfer verification program 150 (e.g., the various modules) may be executed on a single computing device (e.g., EUD 103).

According to one embodiment, the communication network may include various types of communication networks, such as the wide area network (WAN) 102, described with reference to FIG. 1. In some embodiments, the WAN may be replaced and/or supplemented by a local area network (LAN), a telecommunication network (e.g., 3G, 4G, 5G), a wireless network, a public switched network and/or a satellite network. In one embodiment, the communication network may enable data to be transferred between two or more user devices (e.g., EUD 103) using short-range wireless technologies, such as, for example, Wi-Fi and/or Bluetooth® (Bluetooth and all Bluetooth-based trademarks and logos are trademarks or registered trademarks of Bluetooth SIG, Inc. and/or its affiliates).

According to one embodiment, the file transfer verification program 150 may include a standalone messaging application (e.g., instant messaging application) or may be integrated into any messaging system (e.g., instant messaging application or social media platform) that allows real-time data transmission over the Internet or another communication network. Generally, the file transfer verification program 150 may ensure that a user does not send a data file to the wrong recipient(s) by providing multiple reminders and requesting at least one confirmation from the user before transmitting the data file to the target recipient(s).

At 202, a request is detected to transmit a file from a user device to a target recipient. According to one embodiment, a user interacting with a messaging application (e.g., instant messaging application) on the user device (e.g., EUD 103) may select one or more files (e.g., data file such as, a photo, a video, an audio, or other document) to be transmitted to one or more recipients selected by the user (e.g., target recipient). In one embodiment, the file transfer verification program 150 running on the user device (e.g., integrated into the messaging application) may detect one or more user interactions and recognize the user interactions as a file transfer request. In one embodiment, the user interactions may include the user selecting a recipient from a contact list and selecting one or more file icons (e.g., file thumbnail image) from a file library, where the file icons represent the data files that the user wishes to share with the selected recipient (e.g., target recipient). In another embodiment, the user interactions may include the user selecting one or more file icons (e.g., file thumbnail image) from a file library and then selecting the recipient from the contact list. In one embodiment, the file transfer verification program 150 may recognize the above user interactions as the file transfer request (e.g., request to transmit files from the user device to the target recipients).

Then at 204, a recipient information associated with the target recipient is extracted. According to one embodiment, in response to the user selecting the target recipient for the selected files for transfer, the file transfer verification program 150 may automatically extract one or more recipient information associated with the target recipient. In one embodiment, the recipient information may include a name of the one or more target recipients, or a group name of multiple target recipients stored as a group. If the target recipient is a group, the file transfer verification program 150 may also extract the number of members in the grouped set of recipients. In one embodiment, the file transfer verification program 150 may capture (e.g., extract) the recipient information from a contact list associated with the user device.

Next at 206, a determination is made as to whether the target recipient is a single recipient. According to one embodiment, the file transfer verification program 150 may determine if the target recipient is a single recipient or multiple recipients based on the recipient information extracted from the contact list of the user device.

If at 206, the file transfer verification program 150 determines that the target recipient is a single recipient, then at 208, the file is marked on the user device using a single-recipient indicator to remind the user that the target recipient is a single recipient. In one embodiment, marking the file with the single-recipient indicator may include marking the file with a recipient name of the single recipient and a first graphical modification indicating that the target recipient includes the single recipient. In one embodiment, marking the file may include marking a file icon (e.g., thumbnail image of the file) representing the file. In one embodiment, the first graphical modification may include a first color (e.g., green or any other color) applied as an overlay or filter to the file icon. In one embodiment, the first graphical modification may include adding a first icon or symbol as an overlay to the file icon. In other embodiments, various other first graphical modifications may be applied to the file icon to inform the user that the target recipient includes the single recipient.

However, if at 206, the file transfer verification program 150 determines that the target recipient is multiple recipients or a group of recipients, then at 210, the file is marked on the user device using a multi-recipient indicator to remind the user that the target recipient is multiple recipients or the group of recipients. In one embodiment, marking the file with the multi-recipient indicator may include marking the file with multiple recipient names corresponding to the multiple recipients (respectively) and a second graphical modification indicating that the target recipient includes multiple recipients. If the file transfer verification program 150 determines, based on the recipient information, that the plurality of recipients is stored as a group in the contact list, the file transfer verification program 150 may mark the file on the user device with the multi-recipient indicator, where the multi-recipient indicator may include a group name associated with the group of the multiple recipients, a group membership number associated with a number of recipients in the group, and the second graphical modification indicating that the target recipient includes the multiple recipients. In one embodiment, the second graphical modification may include a second color (e.g., red or any other color that is different from the first color) applied as an overlay or filter to the file icon. In one embodiment, the second graphical modification may include adding a second icon or symbol as an overlay to the file icon. In other embodiments, various other first graphical modifications may be applied to the file icon to inform the user that the target recipient includes multiple recipients. In one embodiment, the first graphical modification may be different from the second graphical modification to differentiate between the target recipient including a single recipient or the target recipient including multiple or a group of recipients.

Then at 212, a confirmation is received from the user device to transmit the file to the target recipient. According to one embodiment, once the selected files are marked using either the single-recipient indicator or the multi-recipient indicator, the file transfer verification program 150 may provide a confirmation mechanism to enable the user to confirm the file transfer. In one embodiment, the confirmation mechanism may include user interface (UI) component such as, for example, a “send” button. Additionally, or alternatively, the confirmation mechanism may include a UI gesture (e.g., swipe) and/or a voice command.

Then at 214, a summary report is displayed on the user device associated with the request to transmit the file from the user device to the target recipient. According to one embodiment, in response to receiving the confirmation from the user device at 212, the file transfer verification program 150 may optionally generate and display the summary report on the user device. In one embodiment, the option to provide the summary report may be configured (e.g., selected) by the user. In one embodiment, the summary report may be provided if the number of recipients meets or exceeds a threshold number of recipients (e.g., more than 100 recipients), if the number of files exceeds a threshold number of files (e.g., more than 10 files), and/or if the file is a certain type of file (e.g., a photo, a video, a confidential file).

In one embodiment, the summary report may be provided as a floating text box (e.g., pop-up box) on a display of the user device. In one embodiment, the summary report may include the recipient names or group name (including number of members in the group) and metadata associated with the files selected for transfer. In one embodiment, the metadata may include one or more of the following: the number of files, the name of each file, the size of each file, and the total file transfer size. In one embodiment, the summary report may further include a final confirmation request (e.g., prompt) for the user.

Then at 216, a final confirmation is received from the user device to transmit the file to the target recipient. According to one embodiment, if the optional summary report is generated and displayed on the user device at 218, the file transfer verification program 150 may provide a final confirmation mechanism to enable the user to confirm the file transfer. In one embodiment, the final confirmation mechanism may be provided in the summary report (e.g., floating text box) and request (e.g., prompt) a final confirmation from the user based on the information provided in the summary report. In one embodiment, the file transfer verification program 150 may wait for the user's final confirmation before executing the file transfer.

Thereafter at 218, the file is transmitted from the user device to the target recipient. According to one embodiment, the user confirmation received at 212 (e.g., first user confirmation) may trigger the file transfer verification program 150 to execute the file transfer at 218. In at least one embodiment, if the optional summary report is provided to the user, the file transfer verification program 150 may wait to receive the final confirmation at 216 (e.g., second user confirmation) before transmitting the file from the user device to the target recipient at 218.

Referring now to FIG. 3, a schematic block diagram of an operational example 300 illustrating the file transfer verification process 200 (FIG. 2) according to at least one embodiment is depicted.

As illustrated in example 300, in one embodiment, a user may request a single-recipient file transfer 302 or a multi-recipient file transfer 304 using a messaging application (e.g., integrated with the file transfer verification program 150) running on the user device. The file transfer verification program 150 may determine whether the request is for the single-recipient file transfer 302 or the multi-recipient file transfer 304, based on extracting the recipient information of the target recipient as described previously with reference to FIG. 2.

When the user requests the single-recipient file transfer 302, the file transfer verification program 150 may automatically mark (e.g., graphically modify) each selected thumbnail image of the file 306 (e.g., representing a corresponding file) with a single-recipient indicator 308, 310. For example, the user may select five thumbnail images 306 representing corresponding photos in a photo library 312. In one embodiment, the single-recipient indicator 308, 310 may include a recipient name 308 corresponding to the name (e.g., “John”) of the target recipient. The single-recipient indicator 308, 310 may also include a first graphical modification 310 indicating that the target recipient includes the single recipient. In example 300, the first graphical modification 310 is illustrated as a box hatching mark, but may include any suitable graphical modification, such as, for example, a distinct color (e.g., green). In one embodiment, the file transfer verification program 150 may provide a first confirmation mechanism 314 (e.g., a “send” button indicating the number of files selected for transfer) to enable the user to confirm the file transfer to the target recipient.

When the user requests the multi-recipient file transfer 304, the file transfer verification program 150 may automatically mark (e.g., graphically modify) each selected thumbnail image of the file 306 (e.g., representing a corresponding file) with a multi-recipient indicator 316, 318, 320. For example, the user may select five thumbnail images 306 representing corresponding photos in the photo library 312. In one embodiment, the multi-recipient indicator 316, 318, 320 may include a group name 316 corresponding to the name of the group (e.g., “Class”) that is the target recipient. The multi-recipient indicator 316, 318, 320 may also include a group membership number 318 associated with a number of recipients in the group (e.g., 150 members in the “Class” group). In one embodiment, the multi-recipient indicator 316, 318, 320 may further include a second graphical modification 320 indicating that the target recipient includes multiple recipients (e.g., 150 recipients). In example 300, the second graphical modification 320 is illustrated as a vertical hatching mark, but may include any suitable graphical modification, such as, for example, a distinct color (e.g., red). As illustrated in example 300, the first graphical modification 310 (e.g., box hatching mark) may be different from the second graphical modification 320 (e.g., vertical hatching mark) to remind or indicate to the user that the target recipient is either a single recipient or multiple recipients. In one embodiment, the file transfer verification program 150 may also provide the first confirmation mechanism 314 (e.g., a “send” button indicating the number of files selected for transfer) in the multi-recipient file transfer 304 to enable the user to confirm the file transfer to the target recipients.

According to one embodiment, the file transfer verification program 150 may also generate and display a summary report 322 on the user device, as described previously with reference to FIG. 2. In one embodiment, the file transfer verification program 150 may receive a first confirmation from the user via the first confirmation mechanism 314 and automatically generate and display the summary report 322. In one embodiment, the summary report 322 may include a first information 324 associated with the files selected for transfer, a second information 326 associated with the target recipient, and a third information 328 requesting a final confirmation for transmitting the file from the user device to the target recipient. In one embodiment, the first information 324 may include the number of files selected, the names of each file, the size of each file, and the total file transfer size. In one embodiment, the second information 326 may include the recipient or group name (including the group membership number). In one embodiment, the third information 328 may include a second confirmation mechanism which may enable the user to provide a final confirmation before the file transfer verification program 150 executes the file transfer to the target recipients.

It is contemplated that the file transfer verification program 150 may provide several advantages and/or improvements to the technical field of real-time communications as described above. The file transfer verification program 150 may also improve the functionality of a computer because the file transfer verification program 150 may enable the computer to provide a way to verify and confirm a file transfer request to ensure that users do not mistakenly send data files to the wrong recipients.

According to one embodiment, the file transfer verification program 150 may enable the computer to detect when a user chooses to send a file to a target recipient and automatically extract recipient information, such as, the name of the recipient or the receiving group. In one embodiment, the file transfer verification program 150 may enable the computer to provide a first reminder to remind the user of who will receive the file, and at the same time remind the user whether the target recipient is an individual or a group. For example, the file transfer verification program 150 may enable the computer to automatically mark and display the names of the recipients or group above the file icon (e.g., thumbnail image of the file). If the target recipient is a group, the file transfer verification program 150 may enable the computer to also extract the number of members in the group and provide a second reminder to remind the user of the number of people in the group who may receive the file. According to one embodiment, the file transfer verification program 150 may enable the computer to provide a third reminder by graphically modifying the selected file icon based on whether the target recipient is an individual/single recipient or a group (e.g., multiple recipients).

According to one embodiment, the file transfer verification program 150 may enable the computer to provide an additional verification by generating and displaying a summary report for the user before the file is transferred to the recipients. In one embodiment, the summary report may include the recipient or group name, the number of files selected by the user to be transferred, the name of each file, the size of each file, and the total size of all the files. In one embodiment, the summary report may include a final confirmation request for the user and the file transfer verification program may wait for the user's final confirmation before transferring the files to the recipient.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting a request to transmit a file from a user device to a target recipient;
extracting a recipient information associated with the target recipient;
marking the file on the user device to indicate the recipient information;
receiving a confirmation from the user device to transmit the file to the target recipient; and
transmitting the file from the user device to the target recipient.

2. The computer-implemented method of claim 1, further comprising:
determining, based on the recipient information, that the target recipient includes a single recipient; and
marking the file on the user device with a single-recipient indicator based on the recipient information indicating the single recipient.

3. The computer-implemented method of claim 1, further comprising:
determining, based on the recipient information, that the target recipient includes a plurality of recipients; and
marking the file on the user device with a multi-recipient indicator based on the recipient information indicating the plurality of recipients.

4. The computer-implemented method of claim 1, wherein marking the file on the user device to indicate the recipient information further comprises:
in response to determining that the target recipient includes a single recipient, marking the file on the user device with a first graphical modification indicating that the target recipient includes the single recipient; and
in response to determining that the target recipient includes a plurality of recipients, marking the file on the user device with a second graphical modification indicating that the target recipient includes the plurality of recipients.

5. The computer-implemented method of claim 1, wherein marking the file on the user device to indicate the recipient information further comprises:
graphically modifying a file icon of the file based on the recipient information.

6. The computer-implemented method of claim 1, further comprising:
displaying a summary report on the user device associated with the request to transmit the file from the user device to the target recipient, wherein the summary report includes a first information associated with the file, a second information associated with the target recipient, and a third information requesting a final confirmation for transmitting the file from the user device to the target recipient.

7. The computer-implemented method of claim 1, wherein extracting the recipient information associated with the target recipient further comprises:
automatically extracting the recipient information associated with the target recipient from a contact list associated with the user device.

8. The computer-implemented method of claim 2, wherein marking the file on the user device with the single-recipient indicator further comprises:
marking the file on the user device with a recipient name of the single recipient and a first color indicating that the target recipient includes the single recipient.

9. The computer-implemented method of claim 3, wherein marking the file on the user device with the multi-recipient indicator further comprises:
marking the file with a plurality of recipient names corresponding to the plurality of recipients and a second color indicating that the target recipient includes the plurality of recipients.

10. The computer-implemented method of claim 3, further comprising:
determining, based on the recipient information, that the plurality of recipients is stored as a group; and
marking the file on the user device with the multi-recipient indicator, wherein the multi-recipient indicator includes a group name associated with the group of the plurality of recipients, a group membership number associated with a number of recipients in the group, and a second color indicating that the target recipient includes the plurality of recipients.

11. A computer system for file transfer verification, the computer system comprising:
one or more processors, one or more computer-readable memories and one or more computer-readable storage media;
program instructions, stored on at least one of the one or more storage media for execution by at least one of the one or more processors via at least one of the one or more memories, to detect a request to transmit a file from a user device to a target recipient;
program instructions, stored on at least one of the one or more storage media for execution by at least one of the one or more processors via at least one of the one or more memories, to extract a recipient information associated with the target recipient;
program instructions, stored on at least one of the one or more storage media for execution by at least one of the one or more processors via at least one of the one or more memories, to mark the file on the user device to indicate the recipient information;
program instructions, stored on at least one of the one or more storage media for execution by at least one of the one or more processors via at least one of the one or more memories, to receive a confirmation from the user device to transmit the file to the target recipient; and
program instructions, stored on at least one of the one or more storage media for execution by at least one of the one or more processors via at least one of the one or more memories, to transmit the file from the user device to the target recipient.

12. The computer system of claim 11, further comprising:
program instructions, stored on at least one of the one or more storage media for execution by at least one of the one or more processors via at least one of the one or more memories, to determine, based on the recipient information, that the target recipient includes a single recipient; and
program instructions, stored on at least one of the one or more storage media for execution by at least one of the one or more processors via at least one of the one or more memories, to mark the file on the user device with a single-recipient indicator based on the recipient information indicating the single recipient.

13. The computer system of claim 11, further comprising:
program instructions, stored on at least one of the one or more storage media for execution by at least one of the one or more processors via at least one of the one or more memories, to determine, based on the recipient information, that the target recipient includes a plurality of recipients; and
program instructions, stored on at least one of the one or more storage media for execution by at least one of the one or more processors via at least one of the one or more memories, to mark the file on the user device with a multi-recipient indicator based on the recipient information indicating the plurality of recipients.

14. The computer system of claim 11, further comprising:
program instructions, stored on at least one of the one or more storage media for execution by at least one of the one or more processors via at least one of the one or more memories, to display a summary report on the user device associated with the request to transmit the file from the user device to the target recipient, wherein the summary report includes a first information associated with the file, a second information associated with the target recipient, and a third information requesting a final confirmation for transmitting the file from the user device to the target recipient.

15. The computer system of claim 13, further comprising:
program instructions, stored on at least one of the one or more storage media for execution by at least one of the one or more processors via at least one of the one or more memories, to determine, based on the recipient information, that the plurality of recipients is stored as a group; and
program instructions, stored on at least one of the one or more storage media for execution by at least one of the one or more processors via at least one of the one or more memories, to mark the file on the user device with the multi-recipient indicator, wherein the multi-recipient indicator includes a group name associated with the group of the plurality of recipients, a group membership number associated with a number of recipients in the group, and a second color indicating that the target recipient includes the plurality of recipients.

16. A computer program product for file transfer verification, the computer program product comprising:
one or more computer-readable storage media;
program instructions, stored on at least one of the one or more storage media, to detect a request to transmit a file from a user device to a target recipient;
program instructions, stored on at least one of the one or more storage media, to extract a recipient information associated with the target recipient;
program instructions, stored on at least one of the one or more storage media, to mark the file on the user device to indicate the recipient information;
program instructions, stored on at least one of the one or more storage media, to receive a confirmation from the user device to transmit the file to the target recipient; and
program instructions, stored on at least one of the one or more storage media, to transmit the file from the user device to the target recipient.

17. The computer program product of claim 16, further comprising:
program instructions, stored on at least one of the one or more storage media, to determine, based on the recipient information, that the target recipient includes a single recipient; and
program instructions, stored on at least one of the one or more storage media, to mark the file on the user device with a single-recipient indicator based on the recipient information indicating the single recipient.

18. The computer program product of claim 16, further comprising:
program instructions, stored on at least one of the one or more storage media, to determine, based on the recipient information, that the target recipient includes a plurality of recipients; and
program instructions, stored on at least one of the one or more storage media, to mark the file on the user device with a multi-recipient indicator based on the recipient information indicating the plurality of recipients.

19. The computer program product of claim 16, further comprising:
program instructions, stored on at least one of the one or more storage media, to display a summary report on the user device associated with the request to transmit the file from the user device to the target recipient, wherein the summary report includes a first information associated with the file, a second information associated with the target recipient, and a third information requesting a final confirmation for transmitting the file from the user device to the target recipient.

20. The computer program product of claim 18, further comprising:
program instructions, stored on at least one of the one or more storage media, to determine, based on the recipient information, that the plurality of recipients is stored as a group; and
program instructions, stored on at least one of the one or more storage media, to mark the file on the user device with the multi-recipient indicator, wherein the multi-recipient indicator includes a group name associated with the group of the plurality of recipients, a group membership number associated with a number of recipients in the group, and a second color indicating that the target recipient includes the plurality of recipients.
